(19) United States
(12) Patent Application Publication
(10) Pub. No.: US 2014/0062812 A1
(43) Pub. Date: Mar. 6, 2014

(54) MULTI-ANTENNA ISOLATION

(71) Applicants: Leslie David Smith, Wilburton Ely (GB); Johan Lucas Gertenbach, Blaustein (DE)

(72) Inventors: Leslie David Smith, Wilburton Ely (GB); Johan Lucas Gertenbach, Blaustein (DE)

(73) Assignee: Cambridge Silicon Radio Limited, Cambridge (GB)

(21) Appl. No.: 13/599,346

(22) Filed: Aug. 30, 2012

(51) Int. Cl. H01Q 1/00; H01Q 1/50

(52) U.S. Cl. 343/730; 343/853

(57) ABSTRACT

An interconnection medium for connecting circuitry, including a ground plane; a first balanced antenna located in a first plane, the first plane being parallel to the ground plane; a second balanced antenna located in a second plane, the second plane being parallel to the first plane; wherein the first balanced antenna and the second balanced antenna are configured such that the magnetic field radiated by the first balanced antenna is orthogonal to the magnetic field radiated by the second balanced antenna, and the electrical field radiated by the first balanced antenna is orthogonal to the electric field radiated by the second balanced antenna.

The following disclosure relates to antennas, particularly to antenna isolation.

There is increasing demand in the marketplace for consumer electronic devices which are ever smaller in size whilst incorporating more functionality. In particular, there is an increasing demand for electronic devices to be able to communicate using a plurality of radio protocols. The radio spectrum has a finite bandwidth, much of which is reserved for specific types of communications. Due to this, and the prevalence of radio communications in modern day life, several radio protocols operate using overlapping frequency bands. It is common for there to be a desire for a single electronic device to communicate using two or more radio protocols which operate using overlapping frequency bands. This problem is particularly acute in the industrial, scientific and medical (ISM) radio band. Many short range communication protocols use the ISM bands, for example Bluetooth™, WiFi™ and near field communication (NFC) devices.

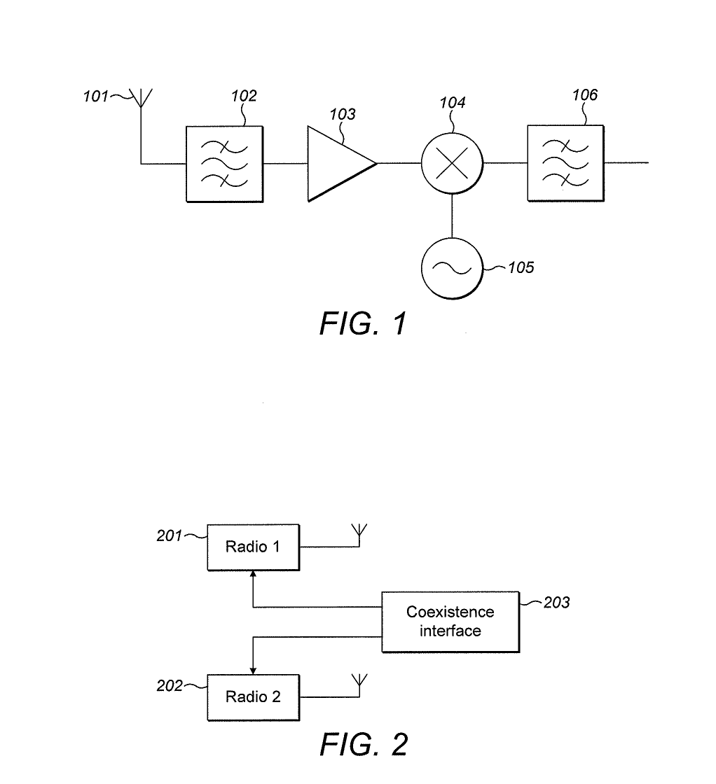

The following describes problems encountered when an electronic device incorporates two radios operating in overlapping frequency bands, using the specific example of the 2.4 GHz ISM band for illustration purposes. Each radio comprises a transmitter and a receiver. FIG. 1 illustrates a simplified receiver architecture for receiving a signal in the ISM band. A signal is received by antenna 101. The received signal is then filtered by band-pass filter (BPF) 102 to select the ISM band (2.4 GHz-2.5 GHZ). The filtered signal is then amplified by low noise amplifier (LNA) 103. The amplified signal is then mixed down from the ISM frequency band to an intermediate frequency band at mixer 104 by multiplying the amplified signal by a signal generated by local oscillator 105. The resulting intermediate frequency signal is then further filtered at band-pass filter 106 to select a channel for further processing. Thus, the LNA 103 and mixer 104 operate in the full ISM band from 2.4 GHz-2.5 GHz.

The ISM band transmitter of one radio in the electronic device is located very close to the ISM band receiver of the other radio. If the transmitter transmits a signal in the ISM band at the same time that the receiver is receiving a wanted signal in the ISM band, problems arise. This is because the receiver will also pick up the transmitted signal. The transmitted signal is in the ISM band and hence will pass through the BPF 102 to the LNA 103. The transmitted signal has a much higher power than the wanted signal, and hence is likely to overload both the LNA 103 and the mixer 104. This causes the LNA and mixer to compress, i.e. to start acting in a non-linear way which affects the signals that they output. This is likely to inhibit detection of the wanted signal. In a device comprising a Bluetooth radio and a WiFi radio, this problem is particularly pronounced when the WiFi radio is transmitting and the Bluetooth radio is receiving because in a typical application, the power of the WiFi transmitter is of the order of ten times or more that of the BT transmitter.

Problems also occur if the two radios transmit at the same time. This causes intermodulation distortion, i.e. the two transmitted signals mix to form additional signals that are not harmonics of either individual transmitted signal, the most significant of these being, but not limited to, the third and fifth-order intermodulation products. Since the transmitted signals are in the same frequency band, the additional signals formed tend to be too close to the transmitted signals to be filtered out. Intermodulation distortion can lead to channels being blocked. Furthermore, intermodulation distortion can lead to the transmitter failing the transmitter mask and spurious products tests which are performed to show that the transmitter complies with the regulations regarding transmitted power limits inside and outside the transmitter band.

Due to these problems, it is necessary to isolate one radio system from the other in a device incorporating both such that interference experienced by one of the systems as a result of the other is not so extreme as to prevent that system from being able to successfully transmit and receive data.

One known way of achieving this isolation is to use a so-called digital “coexistence” interface. This is illustrated in FIG. 2. Coexistence interface 203 connects radio 1 201 and radio 2 202 together. The Coexistence interface 203 uses software arbitration and scheduling to control which of radios 1 and 2 transmits and receives at any particular time. This arbitration is arranged such that (i) the radios do not transmit at the same time, (ii) neither radio transmits whilst the other radio is receiving, and (iii) neither radio receives whilst the other radio is transmitting. It is possible for both radios to be receiving simultaneously if their front-end architecture supports this function. Thus at any one instant in time, only one of the following three actions can occur: (i) radio 1 is transmitting, (ii) radio 2 is transmitting, (iii) either radio 1 or radio 2 or both radios are receiving. Although effective at achieving the desired radio isolation, this solution potentially suffers from low data throughput since the radios cannot simultaneously transmit and receive.

Another known way of achieving the isolation is to increase the spatial separation of the antennas of the radios. This solution runs contrary to the ever present market demand to decrease the size of products. In order to achieve adequate isolation using two chip antennas, a spatial separation of ^{˜}1 m is required, which is incompatible with the size of any handheld device. However, by achieving isolation of the antennas in this way, both radios can transmit and receive at the same time. Thus, this solution does not suffer from the low data throughput problem of the coexistence solution.

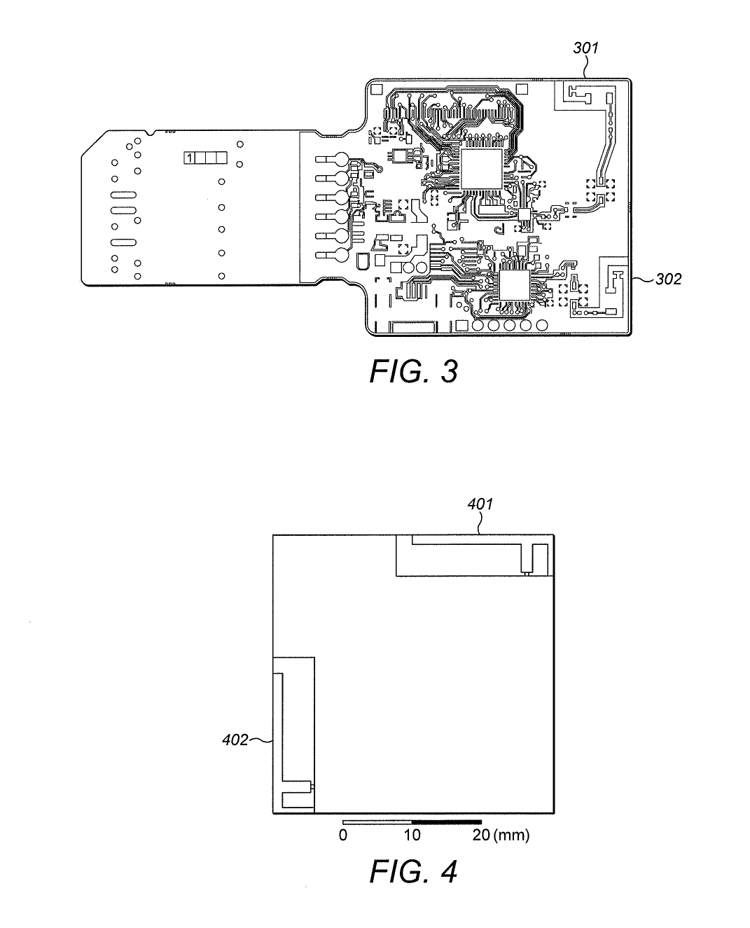

Efforts have been made to find a small antenna solution which achieves the desired isolation. One approach has been to orientate the two antennas at right-angles to each other on a printed circuit board (PCB). Such an orientation reduces the mutual interference of the two antennas radiation patterns. FIGS. 3 and 4 illustrate this approach. In FIG. 3, chip antennas 301 and 302 are orientated at right angles to each other. In FIG. 4, inverted-F antennas 401 and 402 are orientated at right-angles to each other in opposite corners of a PCB. However, these antenna configurations do not achieve sufficient isolation to enable the two radios to successfully transmit and receive data simultaneously.

Antenna isolation is also important in short-range radio devices, particular when they are used indoors. Such devices suffer from multipath propagation. This is when the transmitted signals take various paths to the receiver. Some signals may take a direct line-of-sight path, whilst others are reflected by obstacles such as walls and people. These signals combine at the receiver resulting in the received signal. When the propagated signals destructively interfere, the received signal is lost. Thus, two or more spatially separated antennas are used in the receiver. Each antenna receives a slightly different set of signals which combine to form the received signal at that antenna. Thus, if two antennas are located one-half wavelength apart, then when one antenna receives a set of signals that destructively interferes resulting in a lost signal, the other antenna receives a set of signals that interferes to form a received signal. However, the effectiveness of this spatial diversity technique is limited by the degree of isolation between the antennas. This is because if the antennas are not sufficiently isolated, there will be some overlap in the signals that the antennas transmit and receive.

Thus there is a need for an antenna configuration that achieves improved antenna isolation and that is suitable for incorporation into small products.

According to a first aspect of the disclosure, there is provided an interconnection medium for connecting circuitry, comprising: a ground plane; a first balanced antenna located in a first plane, the first plane being parallel to the ground plane; a second balanced antenna located in a second plane, the second plane being parallel to the first plane; wherein the first balanced antenna and the second balanced antenna are configured such that the magnetic field radiated by the first balanced antenna is orthogonal to the magnetic field radiated by the second balanced antenna, and the electrical field radiated by the first balanced antenna is orthogonal to the electric field radiated by the second balanced antenna.

Suitably, the first balanced antenna and the second balanced antenna are positioned such that a radiation null of the first balanced antenna's radiation field is directed at a radiation null of the second balanced antenna's radiation field.

Suitably, the first balanced antenna is a dipole antenna.

Suitably, the interconnection medium further comprises a balun, wherein the balun is configured to feed differential signals to the dipole antenna.

Suitably, the second balanced antenna is a slot antenna.

Suitably, the second plane is the ground plane.

Suitably, the interconnection medium further comprises a microstrip, wherein the microstrip is configured to feed differential signals to the slot antenna.

Suitably, the interconnection medium is a printed circuit board.

Suitably, the interconnection medium further comprises circuitry connected to the first balanced antenna and the second balanced antenna.

Suitably, the circuitry is located in the first plane.

Suitably, the interconnection medium further comprises a first radio operable in accordance with a first radio protocol which utilises a first frequency band and a second radio operable in accordance with a second radio protocol which utilises a second frequency band that overlaps the first frequency band, wherein the first radio is connected to the first balanced antenna, and wherein the second radio is connected to the second balanced antenna.

Suitably, the interconnection medium is configured such that the first balanced antenna transmits data from the first radio at the same time that the second balanced antenna transmits data from the second radio.

Suitably, the interconnection medium is configured such that the first radio receives data from the first balanced antenna at the same time that the second radio receives data from the second balanced antenna.

Suitably, the interconnection medium is configured such that the first balanced antenna transmits data from the first radio at the same time that the second radio receives data from the second balanced antenna.

Suitably, the interconnection medium is configured such that the second balanced antenna transmits data from the second radio at the same time that the first radio receives data from the first balanced antenna.

Suitably, the first radio protocol is Bluetooth™ and the second radio protocol is WiFi™.

Suitably, the interconnection medium further comprises a radio connected to both the first balanced antenna and the second balanced antenna, the interconnection medium being configured such that the radio receives spatially offset versions of a received signal from the first balanced antenna and the second balanced antenna.

Suitably, the interconnection medium further comprises a radio connected to both the first balanced antenna and the second balanced antenna, the interconnection medium being configured such that the first balanced antenna and the second balanced antenna transmit the same signal from the radio.

The present disclosure will now be described by way of example with reference to the accompanying figures. In the figures:

FIG. 1 is a schematic diagram of a conventional receiver architecture;

FIG. 2 illustrates a coexistence interface providing arbitration between two radios;

FIG. 3 illustrates a known arrangement of chip antennas on a PCB;

FIG. 4 illustrates a known arrangement of inverted-F antennas on a PCB;

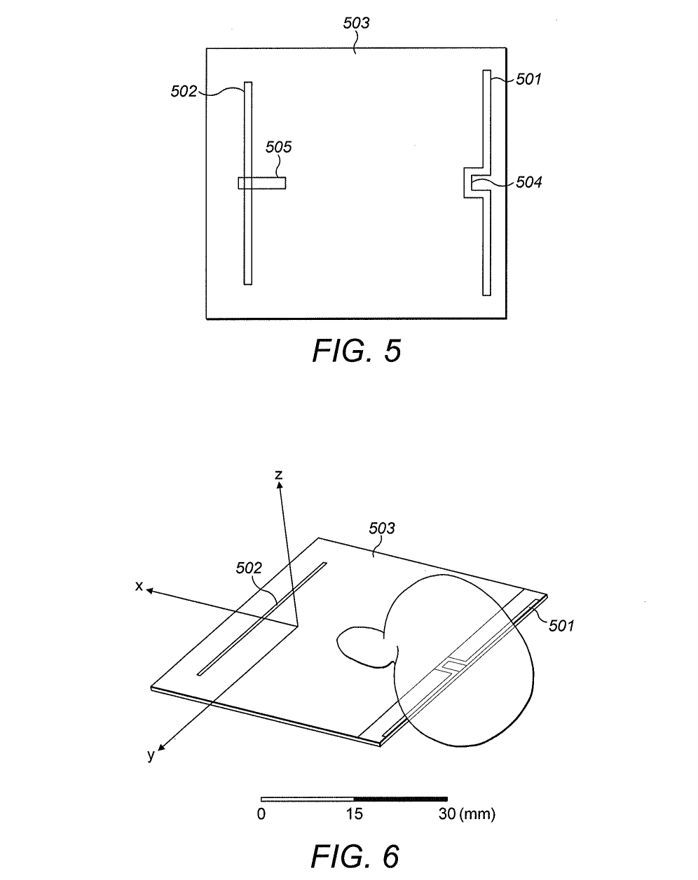

FIG. 5 illustrates an exemplary antenna arrangement comprising a dipole antenna and a slot antenna; and

FIG. 6 illustrates the radiation field emitted by a dipole antenna in the presence of a ground plane.

FIG. 5 illustrates an exemplary antenna arrangement for providing improved antenna isolation. The antenna arrangement comprises two antennas.

The two antennas 501 and 502 are balanced antennas. Balanced antennas are fed with differential signals, i.e. signals which are equal in magnitude but opposite in phase. Generally, balanced antennas are fed at their centre. Balanced antennas impart minimal radio frequency (RF) currents on the ground plane. In the specific example of FIG. 5, a dipole antenna 501 and a slot antenna 502 are illustrated.

Each antenna in the antenna arrangement of FIG. 5 is located in a plane parallel to the plane of the other antenna and parallel to the ground plane. In the specific example of FIG. 5, the slot antenna 502 is located in the ground plane 503, and the dipole antenna 501 is located in a layer adjacent to and parallel to the ground plane 503. Suitably, the feed 505 to the slot antenna 502 and further circuitry 504 are also connected in the plane comprising the dipole antenna 501.

Suitably, the dipole antenna is a half-wave antenna, i.e. the dipole consists of two quarter-wavelength elements. This means that there is a node at one end of the dipole and an anti-node at the other end of the dipole, i.e. this arrangement yields the greatest voltage differential. A dipole antenna usually radiates a torus-shaped radiation field, with a null along the axis of the dipole elements. However, in the implementation illustrated in FIG. 6, the ground plane acts to truncate the portion of the torus radiation field that is directed towards the ground plane. FIG. 6 illustrates the radiation field emitted by the dipole antenna in the presence of the ground plane. The use of a dipole antenna thus reduces the RF currents generated in the circuitry on the ground plane. A slot antenna has a radiation pattern with a null in the plane of the slot antenna perpendicular to the direction of the slot antenna, a partial null in the plane of the slot antenna in the direction of the slot antenna, and maxima perpendicular to the plane of the slot antenna. The use of a slot antenna thus reduces the RF currents generated in the circuitry on the ground plane.

The antennas arrangements illustrated in FIGS. 3 and 4 have significant radio frequency currents flowing in the ground plane. In this configuration, chip antennas, inverted-F antennas and meander antennas are all examples of monopole antennas. They require a connection to ground. The ground acts like the second element of a dipole. Due to the larger area of the ground plane relative to the primary element, it is actually the ground plane that radiates more than the smaller primary element. Thus, the ground plane is a significant part of the antenna system. When two monopole antennas are located on the ground plane, as illustrated in FIGS. 3 and 4, they both share the same common ground plane. Since the grounds of each antenna are coupled together, even when the antennas are located orthogonal to each other, their radiation patterns are not orthogonal. Their radiation patterns are very similar, and hence the antennas have very poor isolation. Since balanced antennas do not require a connection to ground, if two balanced antennas are located on the same ground plane, they do not couple via the ground plane.

In the specific example of FIG. 5, a dipole antenna 501 and a slot antenna 502 are illustrated. A pair of the same type of balanced antenna, for example two dipole antennas or two slot antennas could be used. However, in order to achieve the desired isolation, the spatial separation of a pair of the same type of balanced antenna would need to be further than is practical for a small device. The dipole antenna and slot antenna can be positioned close together whilst still achieving the desired isolation because they are complimentary antennas. Complimentary antennas have radiation patterns with orthogonal electric and magnetic fields. In other words the magnetic field radiated by the first antenna is orthogonal to the magnetic field radiated by the second antenna. Similarly, the electric field radiated by the first antenna is orthogonal to the electric field radiated by the second antenna. Suitably, the radiation fields of the two antennas are the same shape. The interchange of the electric and magnetic fields of the two complementary antennas is known as polarization diversity. By implementing the dipole antenna and slot antenna in adjacent parallel planes, there is little coupling between their radiation fields, which produces a strongly isolated arrangement.

Although a dipole antenna and a slot antenna have been described as an example, other pairs of antennas which exhibit orthogonal electric and magnetic fields could be used.

Preferably, the balanced antennas exhibit orthogonal electric and magnetic fields when they are located in parallel planes. For example, the balanced antennas may be located in the same plane. This enables the antennas to be conveniently incorporated into a small product.

Suitably, the antennas are fabricated by printing onto a PCB. In the case of a slot antenna, a slot is removed from the PCB in order to form the slot antenna. The PCB is an interconnection medium for connecting circuitry. For example, the PCB connects the antennas to further circuitry for example radio circuitry. Other forms of interconnection medium could be used. For example, the circuitry could be encased by resin. Preferably, the interconnection medium is a dielectric material(s).

Preferably, the balanced antennas are orientated relative to one another such that a radiation null of the first antenna's radiation field is directed at a radiation null of the second antenna's radiation field. In the arrangement of FIG. 5, this is achieved when the antennas are parallel to one another as shown. The slot antenna has a radiation null in the plane of the slot antenna perpendicular to the direction of the slot antenna. Thus, when the slot antenna and the dipole antenna are parallel to each other, the radiation null of the slot antenna is directed at the dipole antenna. Orientating the slot antenna and dipole antenna parallel to each thus achieves further antenna isolation.

If a balanced antenna is connected to on-chip circuitry which has a single-ended output, then suitably a balun is used to feed differential signals to the balanced antenna. On FIG. 5, balun 504 feeds dipole antenna 501. Balun 504 receives common-mode signals from the on-board circuitry and converts them to balanced signals. Balun 504 provides the balanced signals to the dipole antenna 501. The balun 504 may be fabricated by printing on the PCB. Alternatively, a lumped balun 504 may be used.

If the balanced antenna is connected to on-chip circuitry which has a differential output, then balun 504 is not required. The differential output of the on-chip circuitry can be fed directly to the balanced antenna.

Suitably, microstrip 505 couples electromagnetic waves to the slot antenna 502. No balun is used to drive slot antenna 502. Microstrip 505 is a metal strip formed on top of a dielectric substrate which separates the metal strip from the ground plane. The metal strip is parallel to the ground plane. The microstrip drives the centre of the slot antenna with differential signals which are equal in magnitude but opposite in phase. The differential signals excite the slot antenna causing it to radiate.

The antenna configuration of FIG. 5 provides antenna isolation of >35 dB in the ISM band. This is 20 dB better than a typical discrete dual antenna implementation as illustrated in FIGS. 3 and 4.

The described antenna arrangement is suitably applied to a device comprising two radios, each of which operates in accordance with a different radio protocol, the two radio protocols operating in overlapping frequency bands. A first one of the two balanced antennas is connected to a first one of the radios. The second one of the two balanced antennas is connected to a second one of the radios. The strongly isolated balanced antenna configuration described enables the radios to be operated independently and at the same time. In other words, both radios can successfully transmit simultaneously; both radios can successfully receive simultaneously; and one radio can successfully receive whilst the other radio successfully transmits.

Suitably, the antenna arrangement of FIG. 5 is applied to an implementation in which one of the two balanced antennas is connected to a Bluetooth transceiver, and the other of the two balanced antennas is connected to a WiFi transceiver.

The described antenna arrangement is suitably applied to a device comprising one radio which is connected to both the first and second balanced antennas. Due to the improved antenna isolation, sufficient transmit and receive diversity is achieved using a smaller antenna array.

Although described with respect to a two antenna system, it is to be understood that the above description can be extended to be used with a system comprising any number of antennas.

It will be understood in this description that the antenna arrangement is designed such that substantially complete isolation of the antennas is achieved. The characteristics described in the description are not intended to necessarily confer absolute isolation of the antennas as a result of the antenna arrangement design. Consequently, references in the description to antennas exhibiting orthogonal electric fields and orthogonal magnetic fields are to be interpreted to mean that those fields are sufficiently orthogonal that substantial isolation of the antennas is achieved. Substantial isolation of the antennas is achieved if, in a small product, one antenna is able to successfully transmit whilst the other antenna is successfully transmitting or receiving. Similarly, references to antennas having the same shaped radiation fields are to be interpreted to mean that the degree of similarity between the compared fields is such that substantial isolation of the antennas is achieved. Similarly, references to a radiation null of an antenna being directed at another antenna are to be interpreted to mean that the direction of the radiation null is sufficiently directed at the other antenna such that substantial isolation of the antennas is achieved.

The applicant draws attention to the fact that the present invention may include any feature or combination of features disclosed herein either implicitly or explicitly or any generalisation thereof, without limitation to the scope of any of the present claims. In view of the foregoing description it will be evident to a person skilled in the art that various modifications may be made within the scope of the invention.

1. An interconnection medium for connecting circuitry, comprising:
a ground plane;
a first balanced antenna located in a first plane, the first plane being parallel to the ground plane;
a second balanced antenna located in a second plane, the second plane being parallel to the first plane;
wherein the first balanced antenna and the second balanced antenna are configured such that the magnetic field radiated by the first balanced antenna is orthogonal to the magnetic field radiated by the second balanced antenna, and the electrical field radiated by the first balanced antenna is orthogonal to the electric field radiated by the second balanced antenna.

2. The interconnection medium claimed in claim 1, wherein the first balanced antenna and the second balanced antenna are positioned such that a radiation null of the first balanced antenna's radiation field is directed at a radiation null of the second balanced antenna's radiation field.

3. The interconnection medium claimed in claim 1, wherein the first balanced antenna is a dipole antenna.

4. The interconnection medium claimed in claim 3, further comprising a balun, wherein the balun is configured to feed differential signals to the dipole antenna.

5. The interconnection medium claimed in claim 1, wherein the second balanced antenna is a slot antenna.

6. The interconnection medium claimed in claim 1, wherein the second plane is the ground plane.

7. The interconnection medium claimed in claim 5, further comprising a microstrip, wherein the microstrip is configured to feed differential signals to the slot antenna.

8. The interconnection medium claimed in claim 1, wherein the interconnection medium is a printed circuit board.

9. The interconnection medium claimed in claim 1, further comprising circuitry connected to the first balanced antenna and the second balanced antenna.

10. The interconnection medium claimed in claim 9, wherein the circuitry is located in the first plane.

11. The interconnection medium claimed in claim 1, further comprising a first radio operable in accordance with a first radio protocol which utilises a first frequency band and a second radio operable in accordance with a second radio protocol which utilises a second frequency band that overlaps the first frequency band, wherein the first radio is connected to the first balanced antenna, and wherein the second radio is connected to the second balanced antenna.

12. The interconnection medium claimed in claim 11, wherein the interconnection medium is configured such that the first balanced antenna transmits data from the first radio at the same time that the second balanced antenna transmits data from the second radio.

13. The interconnection medium claimed in claim 11, wherein the interconnection medium is configured such that the first radio receives data from the first balanced antenna at the same time that the second radio receives data from the second balanced antenna.

14. The interconnection medium claimed in claim 11, wherein the interconnection medium is configured such that the first balanced antenna transmits data from the first radio at the same time that the second radio receives data from the second balanced antenna.

15. The interconnection medium claimed in claim 11, wherein the interconnection medium is configured such that the second balanced antenna transmits data from the second radio at the same time that the first radio receives data from the first balanced antenna.

16. The interconnection medium claimed in claim 11, in which the first radio protocol is Bluetooth™ and the second radio protocol is WiFi™.

17. The interconnection medium claimed in claim 1, further comprising a radio connected to both the first balanced antenna and the second balanced antenna, the interconnection medium being configured such that the radio receives spatially offset versions of a received signal from the first balanced antenna and the second balanced antenna.

18. The interconnection medium claimed in claim 1, further comprising a radio connected to both the first balanced antenna and the second balanced antenna, the interconnection medium being configured such that the first balanced antenna and the second balanced antenna transmit the same signal from the radio.
